(19) United States
(12) Patent Application Publication
(10) Pub. No.: US 2025/0378412 A1
(43) Pub. Date: Dec. 11, 2025

(54) COMPUTER-AUTOMATED SYSTEMS AND METHODS FOR GENERATING SOFTWARE DEVELOPMENT METRICS FOR USE IN DILIGENCE

(71) Applicant: StartOS Inc., New Providence, NJ (US)

(72) Inventors: Jason Nichols, New Providence, NJ (US); Sean Conrad, Maplewood, NJ (US)

(73) Assignee: StartOS Inc., New Providence, NJ (US)

(21) Appl. No.: 18/791,723

(22) Filed: Aug. 1, 2024

Related U.S. Application Data
(60) Provisional application No. 63/657,325, filed on Jun. 7, 2024.

(51) Int. Cl. G06Q 10/0639; G06F 8/71

(52) U.S. Cl. CPC G06Q 10/06395; G06F 8/71

(57) ABSTRACT

One embodiment of the present invention relates to a computer-automated system and method for evaluating software development metrics to enhance the diligence process and detect source code plagiarism. The system integrates technical and financial metrics to assess the productivity and economic impact of software developers. It includes a plurality of data sources, such as work product data sources containing source code and financial data sources detailing compensation. The system processes and analyzes this data to generate outputs reflecting worker performance and financial efficiency. Key features include complexity analysis of source code, sentiment analysis, and outlier detection in financial transactions. The system provides synthesized outputs, such as dashboards and reports, which are reviewed and approved before being shared with requesters. This invention offers a comprehensive, secure, and efficient approach to quantifying developer contributions, facilitating better investment decisions and operational assessments within the software development industry.

### CROSS-REFERENCE TO RELATED APPLICATIONS

This application claims priority to U.S. Prov. Pat. App. No. 63/657,325, filed on Jun. 7, 2024, entitled, “Computer-Automated Systems and Methods for Calculating Software Development Metrics for Use in Diligence,” which is hereby incorporated by reference herein.

### BACKGROUND

In the realm of software development, assessing the productivity and profitability of individual developers or teams has traditionally been a complex challenge. Companies and investors often struggle to quantify the value contributed by software developers, as the metrics used are either overly simplistic or do not incorporate relevant financial data. This lack of comprehensive analysis tools leads to difficulties in making informed decisions regarding investments, acquisitions, or internal assessments of software development efficiency.

Existing systems primarily focus on technical metrics such as code complexity, lines of code, and other software development parameters. However, these systems typically operate in isolation from financial metrics, which are crucial for a complete assessment of developer productivity in relation to cost. This narrow focus solely on technical metrics results in an incomplete picture of a developer's true economic impact on an organization.

Moreover, current methods often require manual data entry or cumbersome integration processes that can lead to errors and data breaches. The security of sensitive data is a persistent concern, as traditional systems might expose critical business and personal information during the data analysis process.

In summary, existing methods for analyzing software developer productivity are cumbersome, limited in scope, and pose security risks. As a result, investors and others who perform due diligence on a company that employs software developers must either engage in a significant amount of manual effort to obtain more comprehensive information about software developers as part of the diligence process, or omit such information from their overall analysis of the target company. In either case, the diligence process suffers.

What is needed, therefore, are improved methods for performing diligence of a target company to obtain a more complete picture of software developer value more quickly, easily, and securely.

### SUMMARY

One embodiment of the present invention relates to a computer-automated system and methods for evaluating software development metrics to enhance the diligence process and detect source code plagiarism. The system integrates technical and financial metrics to assess the productivity and economic impact of software developers. It includes a plurality of data sources, such as work product data sources containing source code and financial data sources detailing compensation. The system processes and analyzes this data to generate outputs reflecting worker performance and financial efficiency. Key features include complexity analysis of source code, sentiment analysis, and outlier detection in financial transactions. The system provides synthesized outputs, such as dashboards and reports, which are reviewed and approved before being shared with requesters. This invention offers a comprehensive, secure, and efficient approach to quantifying developer contributions, facilitating better investment decisions and operational assessments within the software development industry.

Other features and advantages of various aspects and embodiments of the present invention will become apparent from the following description and from the claims.

### BRIEF DESCRIPTION OF THE DRAWINGS

FIG. 1 is a dataflow diagram of a system for analyzing source data to generate output representing the performance of one or more workers according to one embodiment of the present invention.

FIG. 2 is a flowchart of a method performed by the system of FIG. 1 according to one embodiment of the present invention.

### DETAILED DESCRIPTION

The present invention relates to a computer-automated system and methods for evaluating software development metrics to enhance the diligence process. The system integrates technical and financial metrics to assess the productivity and economic impact of software developers. It includes a plurality of data sources, such as work product data sources containing source code and financial data sources detailing compensation. The system processes and analyzes this data to generate outputs reflecting worker performance and financial efficiency. Key features include complexity analysis of source code, sentiment analysis, and outlier detection in financial transactions. The system provides synthesized outputs, such as dashboards and reports, which are reviewed and approved before being shared with requesters. This invention offers a comprehensive, secure, and efficient approach to quantifying developer contributions, facilitating better investment decisions and operational assessments within the software development industry.

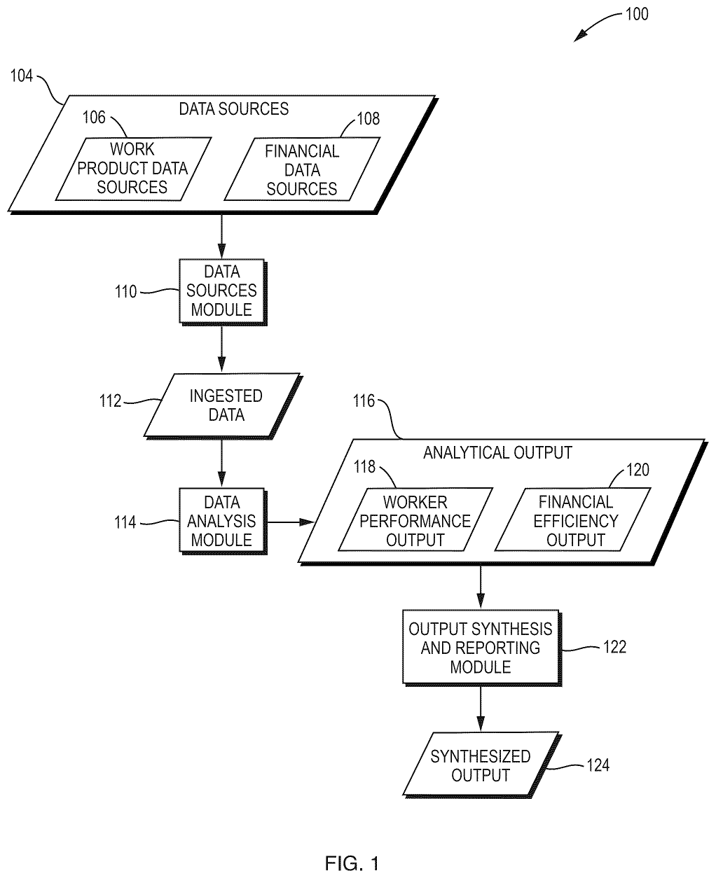

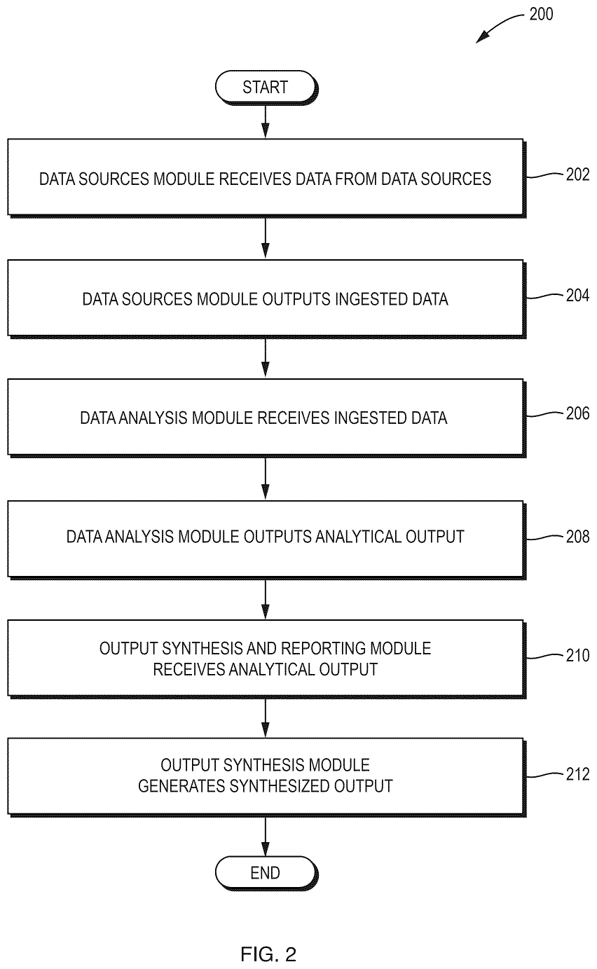

Referring to FIG. 1, a dataflow diagram is shown of a system 100 for analyzing source data to generate output representing the performance of one or more workers (e.g., software developers). Referring to FIG. 2, a flowchart is shown of a method 200 performed by the system 100 according to one embodiment of the present invention.

The system 100 includes a plurality of data sources 104. The plurality of data sources 104 may, for example, include a work product data source 106 and a financial data source 108. The work product data source 106 may include any of a variety of data generated by and/or associated with one or a plurality of workers. As an example, the work product data source 106 may include source code written, generated by, and/or otherwise associated with one or a plurality of software developers. As will be described in more detail below, the work product data source 106 may include metadata which may associate work product (e.g., source code) within the work product data source 106 with one or more corresponding workers (e.g., the worker(s) who created (e.g., wrote) that work product). Although the work product data source 106 is referred to herein as a data “source,” in practice the work product data source 106 may include one or a plurality of data sources.

The work product data source 106, which includes source code, can be implemented using various data sources at different levels of abstraction. These data sources range from high-level platforms to more detailed, specific tools that manage and store source code. Below are examples at high, medium, and low levels of abstraction, including popular commercial platforms that could be used to implement the work product data source 106.

At a high level, the work product data source 106 may be any system that stores and/or serves outputs (e.g., digital data) created by one or more workers. In the context of workers who are software developers, this may include, for example:
Integrated Development Environments (IDEs): While primarily used for coding, IDEs often have local history features that can serve as a source of work product data.
Cloud-Based Development Platforms: Platforms like AWS Cloud9 or Microsoft Visual Studio Online, which not only provide coding environments but also store versions of the code being developed.

More specifically, the work product data source 106 may include one or more systems designed for version control and/or collaborative coding, which are used for tracking changes and contributions by individual developers. Examples of these include:
Version Control Systems (VCS): These are tools specifically designed to manage changes to documents, programs, and other information stored as files.
Git: A distributed version control system that handles everything from small to very large projects with speed and efficiency.
Subversion (SVN): A centralized version control system that records changes to files and directories over time.

Even more specifically, the work product data source 106 may, for example, be implemented using specific instances or deployments of version control systems, configured for particular organizational needs. Examples of these include GitHub, GitLab, and Bitbucket.

The work product data source 106 may include any of a variety of data types that are relevant to assessing the productivity and contributions of software developers. An example is the inclusion of data from ticketing systems, such as those which are commonly used in customer support and project management contexts. The work product data source 106 may include data from customer support ticketing systems and/project management ticketing systems. Data from customer support ticketing systems can provide insights into how software developers interact with end-users, manage and resolve issues, and contribute to customer satisfaction and product improvement. This data may include records of bug reports, feature requests, user feedback, and the developers' responses and resolutions. Including this data allows the system 100 to assess the impact of developers on customer relations and product reliability, which are crucial metrics for evaluating developer effectiveness and the quality of the software.

Data from project management ticketing systems typically includes information on task assignments, progress updates, completion statuses, and time logs related to specific development projects or tasks. This data helps in tracking the contributions of individual developers to various projects, their efficiency in handling tasks, and their ability to meet deadlines and project goals. By analyzing this data, the system 100 can generate detailed insights into the productivity, work habits, and project impact of software developers, facilitating a comprehensive evaluation of their performance.

Incorporating data from ticketing systems into the work product data source 106 provides several advantages, such as enabling a more holistic assessment of a developer's role and effectiveness across different aspects of software development, from coding to customer interaction and project management. Incorporating ticketing system data also offers enhanced visibility into the day-to-day operations and challenges faced by developers, providing context that can be crucial for understanding productivity metrics and developmental outcomes. Furthermore, the integration of diverse data sources like ticketing systems facilitates richer, data-driven insights into developer performance, supporting better-informed decision-making processes regarding promotions, training needs, and project assignments.

Another example of data that may be included in the work product data sources 106 is documentation that outlines software architecture, design choices, and/or specifications. Such data may provide insights into a developer's ability to plan and architect complex systems. As yet another example, information from code reviews, including comments, approvals, and discussions about code changes, may be included in the work product data source 106, and may offer valuable insights into a developer's interaction with peers and their influence on improving code quality and adhering to best practices.

The work product data source 106 may include, for example, data related to unit tests, integration tests, code coverage metrics, and bug reports. Such data may provide a deeper understanding of a developer's commitment to quality and their effectiveness in ensuring robust, error-free software. The work product data source 106 may include, for example, logs from continuous integration/continuous deployment (CI/CD) pipelines that detail build successes, failures, and deployment frequencies can help assess a developer's efficiency in integrating and delivering code into production environments. The work product data source 106 may include, for example, records of performance improvements, such as refactoring efforts, optimization of algorithms, and enhancements to scalability and efficiency, can highlight a developer's skills in enhancing the software post-initial development.

The work product data source 106 may include, for example, data from user interactions, feedback forms, and usability tests. Such data may provide insights into how well the software meets user needs and how effectively the developer addresses user-centric issues. The work product data source 106 may include, for example, educational and training materials, such as contributions of the software developers to internal wikis, training sessions, and mentorship programs. Such data may indicate a developer's role in knowledge sharing and team skill enhancement, which are important for overall team productivity. The work product data source 106 may include, for example, information from security audits, including identified vulnerabilities and the actions taken to resolve them. Such information may be helpful for understanding a developer's awareness and responsiveness to security best practices.

The financial data source 108 may include any of a variety of financial data associated with one or a plurality of workers, such as the workers who are associated with the work product data source 106. As will be described in more detail below, the system 100 may use the data in the financial data source 108 to calculate and assess the financial productivity and efficiency of the workers, particularly in relation to the value of the work products they generate. Although the financial data source 108 is referred to herein as a data “source,” in practice the financial data source 108 may include one or a plurality of data sources.

The financial data source 108 may, for example, include payroll data which details the compensation paid to the workers who created the data in the work product data source 106 for their contributions to that work product. By integrating this financial data with the technical data from the work product data source 106, the system 100 may perform nuanced analyses that reveal insights into cost-effectiveness and return on investment (ROI) for each worker's contributions. Such payroll data may, for example, include data representing the salaries, bonuses, and/or other forms of compensation paid to the workers. This data helps in understanding the direct financial costs associated with the production of the work product created by the workers

The financial data source 108 may include data representing additional financial benefits provided to the workers, such as health insurance, stock options, and retirement plans, which contribute to the total cost of employment. The financial data source 108 may include financial data related to specific projects or tasks that workers are involved in, which might include allocated budgets, actual spending, and financial outcomes of projects. The financial data source 108 may include performance-related financial metrics, such as data that links financial rewards to specific performance metrics or outcomes, such as bonuses based on project success or revenue generated from a product developed by the workers.

In addition to compensation-related data, the financial data source 108 may also encompass data related to the costs of hosting and maintaining software systems in cloud environments, as well as utilization metrics such as CPU and memory usage. This data may, for example, be sourced from various cloud service providers and integrated into the system 100. Including utilization metrics provides a more granular view of resource consumption, which is essential for guiding cost discussions and optimizing cloud resource allocation.

The financial data source 108 may include, for example, training and development costs associated with the software developers, such as expenses related to professional development, e.g., training courses, certifications, conferences, and workshops. These costs may provide insights into the investment made in developing a developer's skills and how it correlates with their productivity and performance improvements.

The financial data source 108 may include, for example, tool and/or license expenses, such as costs associated with software licenses, development tools, and subscriptions used by developers to perform their tasks. Analyzing these expenses may help to assess the cost-effectiveness of tools and technologies used by developers.

The financial data source 108 may include, for example, operational overheads, such as indirect costs associated with maintaining the development environment, including utilities, office space, hardware, and support services. These overheads may impact the total cost of employment and may be considered by embodiments of the present invention when evaluating financial efficiency.

The financial data source 108 may include, for example, travel and accommodation expenses. For developers who travel for work, such as attending client meetings, workshops, or on-site collaborations, the costs of travel and accommodation may be relevant. These expenses might be particularly significant for consultants or developers working in client-facing roles.

The financial data source 108 may include, for example, research and development expenditures. Specific research and development costs that can be directly attributed to innovation and product development initiatives led by developers may be analyzed by embodiments of the present invention to determine the ROI on R&D activities.

By incorporating both cost and utilization data, the system 100 may deliver comprehensive insights into the total cost of ownership (TCO) of software projects. This analysis is crucial for stakeholders as it aids in making well-informed decisions regarding resource allocation, budgeting, and the financial viability of employing cloud technologies in software development processes. Understanding the interplay between resource utilization and associated costs allows organizations to strategically manage their cloud infrastructure, ensuring that they are not only meeting their developmental needs but also doing so in a cost-effective manner.

The financial data source 108 may be implemented in any of a variety of ways. For example, at a high level, the financial data source 108 may include any kind of financial management system that aggregates and analyzes financial data across an organization. The financial data source 108 may include, for example, an Enterprise Resource Planning (ERP) systems, which integrates various functions including finance, HR, and operations, providing a holistic view of the financial data related to workers, such as SAP ERP or Oracle NetSuite.

The financial data source 108 may include a Human Resources Information System (HRIS), which is a system that manages employee data, including payroll, benefits, and compensation. Examples of HRIS systems are Workday and BambooHR. The financial data source 108 may include a payroll system, which is a dedicated system that manages the payment of wages and salaries. Examples of payroll systems include ADP and Paychex.

More specifically, the financial data source 108 may be implemented using specific tools or software solutions that handle detailed financial transactions and reporting, such as accounting software (e.g., QuickBooks or Xero) and/or project costing tools (e.g., Microsoft Project, Smartsheet).

The financial data source 108 may include or obtain data from one or more banks. This integration allows the system 100 to access real-time financial transactions, account balances, and other relevant financial information associated with the workers. By linking directly with banking institutions, the financial data source 108 can automatically pull detailed compensation data, such as salaries, bonuses, and other forms of direct monetary compensation that are processed through these banks. This direct link ensures that the data in the financial data source 108 is accurate, up-to-date, and reflective of the actual financial transactions occurring in relation to the workers.

The financial data source 108 may also include or obtain data from one or more cryptocurrency wallets. As workers may receive parts of their compensation in cryptocurrencies, or may engage in transactions relevant to their employment using digital currencies, it may be helpful for the financial data source 108 to capture this aspect of financial activity. By linking to cryptocurrency wallets, the system 100 can track and analyze transactions made in cryptocurrencies, including the receipt of digital assets as part of compensation packages or payments for specific projects or tasks.

The system 100 also includes a data sources module 110. In general, the data sources module 110 receives data from the plurality of data sources 104 (e.g., the work product data source 106 and/or the financial data source 108) (FIG. 2, operation 202) and processes such data to produce ingested data 112 as output (FIG. 2, operation 204). A variety of techniques that the data sources module 110 may use to receive data from the plurality of data sources 104 and to generate the ingested data 112 will be described below. Although the data sources module 110 may generate data based on the data received from the plurality of data sources 104, such that the ingested data 112 may include generated data which was not present in the plurality of data sources 104, the ingested data ingested data 112 may also include data which was present in the plurality of data sources 104.

The data sources module 110 may receive the data from the plurality of data sources 104 in any of a variety of ways. For example, the system 100 may execute an invitation process that is a preliminary step which facilitates the subsequent data exchange between a requester (e.g., an investor) and a target (e.g., a company in which the investor is considering investing). For example, the invitation process may begin when an investor (referred to more generally herein as a “requester”) identifies a potential investment or acquisition target. To initiate due diligence or further engagement, the requester may send an electronic invitation to the target company. This invitation may be the first step in establishing a data-sharing relationship that will allow the requester to assess the target's value accurately.

The invitation process may be implemented using various computerized methods, ensuring efficiency, traceability, and security. For example, the invitation process may include sending an invitation via email. This can be done using standard email services or through a more secure, encrypted email system if confidentiality is a concern. As another example, a specialized platform may facilitate the invitation process by providing structured workflows for sending invitations, tracking responses, and managing subsequent data exchanges. As yet another example, a custom web portal may be used to guide the requester through the necessary steps to formally issue an invitation, ensuring all required information is provided. As yet another example, one or more application program interfaces (APIs) may be used to integrate the invitation process with other business systems (e.g., CRM systems), thereby automating the invitation process based on certain triggers or business rules.

Given the potentially sensitive nature of the information exchanged following the invitation, any of a variety of security measures may be implemented to maintain the security of sensitive data. This may include, for example, using secure transmission protocols (e.g., HTTPS, SSL/TLS), data encryption, and/or digital signatures to authenticate the identity of the parties involved.

The target may accept the invitation from the requester in any of a variety of ways. For example, the target may send a confirmation email back to the requester to accept the invitation. Such an invitation may include any text which indicates acceptance of the invitation. As another example, and to ensure the authenticity and non-repudiation of the acceptance, one or more digital signatures may be used to implement the target's acceptance of the invitation, such as by the target signing a digital document that formally accepts the invitation. If the requester has a dedicated portal for managing investments or acquisitions, the target may log in to this portal and formally accept the invitation through a user interface designed for this purpose. For organizations that use enterprise resource planning (ERP) or customer relationship management (CRM) systems, the acceptance may be recorded and managed within these systems. One or more APIs may be used to automate the acceptance process, especially when integrating with other systems, such as CRM or ERP. The target may trigger an API call that records the acceptance in both the requester's and the target's systems. Secure messaging platforms that comply with industry standards may be used to send and receive acceptance notifications. Such platforms offer end-to-end encryption, ensuring that the acceptance is communicated securely.

After the target accepts the invitation from the requester, the target may select a pre-existing account of the target with the requester or create a new account. In either case, the target's account will facilitate further interactions and data exchanges between the requester and the target. This account serves as a centralized repository for information associated with the target, streamlining communication and ensuring that all necessary data is readily accessible for due diligence or other evaluative processes. The system 100 may, for example, prompt the target to create an account on the requester's platform or system, such as through a dedicated web portal, a third-party service, or directly within an enterprise system. During account creation, the target may be required to provide basic information such as company name, contact details, and other relevant organizational details. Security measures such as setting up a strong password, multi-factor authentication, and security questions may be used during this phase to protect the account.

As mentioned above, the data sources module 110 retrieves data from the plurality of data sources 104. The data sources module 110 may use any of a variety of methods to retrieve data from the plurality of data sources 104, each tailored to meet specific security and operational needs. In one such method, the data sources module 110 establishes one or more links to the target's data sources 104 and retrieves data from the plurality of data sources 104 via that link. For example, the data sources module 110 may establish one or more links to each of the work product data sources 106 and establish one or more links to each of the financial data sources 108. The data sources module 110 may establish such links using any of a variety of techniques, such as by using OAuth. Examples of other technologies that may be used to implement such a link include federated identity management systems (e.g., Security Assertion Markup Language (SAML)), OpenID Connect, Kerberos, LDAP (Lightweight Directory Access Protocol), JWT (JSON Web Tokens), APIs (e.g., RESTful APIs), SSL/TLS (Secure Sockets Layer/Transport Layer Security), web services (e.g., Simple Object Access Protocol (SOAP) and/or RESTful web services), and VPN (Virtual Private Network) technology.

More generally, in the link-based approach, the data sources module 110 establishes a secure link (e.g., connection) with one or more of the plurality of data sources 104 using any of a variety of authentication and/or authorization technologies. Once this link is established, the data sources module 110 may retrieve data through this secure channel, whether through a pull mechanism, a push mechanism, or any combination thereof.

A key benefit of this link-based approach is that it allows the data sources module 110 to extract necessary data without directly accessing the target's data environment, e.g., without the data sources module 110 logging into the target's internal systems (e.g., databases). For example, the data sources module 110 may use such a link to obtain work product data from one of the work product data sources 106 without directly accessing that work product data source's data environment, such as by using any of the technologies described above. As another example, the data sources module 110 may use such a link to obtain financial data from one of the financial data sources 108 without directly accessing that financial data source's data environment, such as by using any of the technologies described above. By doing so, the link-based approach ensures that the data sources module 110, as well as the requester more generally, do not interact directly with the sensitive internal systems of the target (e.g., the plurality of data sources 104). This method not only enhances the security of the data exchange by minimizing potential exposure but also maintains the integrity and confidentiality of the target's data sources. This embodiment is especially crucial in scenarios where data sensitivity and privacy are paramount, providing a secure bridge to access required data while upholding stringent security standards.

In contrast, some examples of extracting data from a target's data environment by accessing that data environment directly include directly querying the target's databases using protocols such as JDBC or ODBC. This method allows for executing SQL queries to retrieve detailed financial records or development logs. Another example of accessing a target's data environment directly is accessing file systems directly to obtain logs, configuration files, or data dumps, which might involve using network file sharing protocols like NFS or SMB. As another example, directly accessing a target's data environment might include interacting with physical or virtual servers directly, using administrative credentials to access specific data not available through external interfaces. Yet another example of direct access is directly integrating with internal APIs that are not exposed externally, such as by deploying parts of the data sources module 110 within the target's infrastructure, allowing for real-time data extraction from systems like internal ERP solutions. Although some embodiments of the present invention may employ techniques such as those just described in order to extract data from some or all of the plurality of data sources 104 by directly accessing the target's data environment, any reference herein to using a “link” to extract data without directly accessing a target's data environment does not include the techniques described above for directly accessing the target's data environment.

The plurality of data sources 104 may, for example, be located within one or more computer systems of the target, and the data sources module 110 may be located within one or more computer systems of the requester. The computer systems of the target and the computer systems of the requester may be physically and/or logically distinct from each other. For example, the computer systems of the target and the computer systems of the requester may be on different networks (e.g., Local Area Networks) from each other. As this implies, the plurality of data sources 104 and the data sources module 110 may be on different networks from each other.

In an alternative embodiment of the system, the data sources module 110 may use an agent-based approach, in which a specialized software agent is installed on the target's computer systems (within what is referred to herein as the target's data environment). The target may, for example, download the agent from the requester's computers and install the agent locally on one or more of the target's computer systems. The agent may be specifically designed to interact with the target's data sources 104, retrieve necessary data, and securely upload it to the data sources module 110, which in this scenario, may function as a server located outside the target's environment.

The agent may have the capability to query, collect, and process data from the plurality of data sources 104. This might involve, for example, accessing databases, file systems, and/or other data repositories. Before transmission to the data sources module 110, the agent may preprocess the data to conform to the formats and structures required by the data sources module 110. This might include data normalization, encryption, and/or compression. As another example, the agent may summarize and/or filter data from the plurality of data sources 104 and provide only the resulting summarized and/or filtered data to the data sources module 110. The agent may securely upload the processed data to the data sources module 110 using encrypted channels to ensure data integrity and confidentiality.

Both the link-based (e.g., OAuth) and agent-based approaches offer distinct methods for retrieving data from the plurality of data sources 104 and providing the retrieved data to the data sources module 110. Each has its advantages and disadvantages, depending on the specific requirements and constraints of the target's environment. For example, benefits of the link-based approach include not requiring the installation of additional software on the target's systems, reducing the complexity of setup and maintenance; easy scalability by providing the ability to handle multiple data sources and targets without significant changes to the target's infrastructure; reduced load on the targets systems; and flexibility in adding new data sources. Advantages of the agent based approach include enhanced security as a result of processing data locally within the target's environment; the ability to customize the agent to meet the unique data needs and security requirements of the target; enabling data to be retrieved offline; and providing the target with greater control over the data, which can be crucial for compliance with stringent data protection regulations. A particular benefit of the agent-based approach is that it may be used to provide to the data sources module 110 only data from the plurality of data sources 104 which are necessary for the other components of the system 100 to perform the functions described below. In this way, the benefits of the system 100 may be obtained in a way that exposes the minimal amount of data necessary from the target (e.g., the plurality of data sources 104) to the requester (e.g., the data sources module 110).

Both the link-based and agent-based embodiments provide the benefit of enabling the data sources module 110 to obtain data automatically from the plurality of data sources 104, thereby reducing or eliminating the need for the target to manually enter data into the data sources module 110.

Although the link-based and agent-based approaches are described herein as alternatives to each other, embodiments of the present invention may use both approaches in any combination. Either the link-based approach or the agent-based approach may use any of a variety of technologies to obtain data from the data sources 104. Examples of such techniques include, individually or in combination with each other or with any of the techniques described above, receiving data from the data sources 104: via one or more APIs, using web scraping and/or web crawling, using a file transfer protocol (e.g., FTP, SFTP, or SCP), using a database connection (e.g., JDBC or ODBC), or using a cloud service API to obtain data from sources hosted on cloud platforms (e.g., AWS, Azure, Google Cloud).

More generally, although the description herein refers to certain specific examples of techniques that the data sources module 110 may use to receive data from the plurality of data sources 104, those techniques are merely examples and do not constitute limitations of the present invention. More generally, the data sources module 110 may use any of a variety of automated techniques to efficiently and securely obtain data from the work product data sources 106 and the financial data source 108.

The data sources module 110 may normalize any of the data retrieved from the plurality of data sources 104 and store the original retrieved data and/or normalized data in a data store of any suitable type. Any of the functions that are described herein as being performed on the retrieved data may be performed on the pre-normalized retrieved data and/or on the normalized retrieved data. As this implies, the ingested data 112 may include the pre-normalized retrieved data and/or the normalized retrieved data. Normalization performed by the data sources module 110 may include, for example, any one or more of the following:
Data Cleaning: Initial cleaning of data to remove duplicates, correct errors, and handle missing values.
Standardization: Converting data into a uniform format, which may involve standardizing date formats, units of measurement, or string formatting (e.g., capitalization).
Scaling: Adjusting data scales so that they are consistent across different sources. For example, converting all currency values to a single currency or normalizing financial figures to a common scale.
Encoding: Transforming categorical data into numerical formats that can be used in mathematical calculations and machine learning models.

The system 100 also includes a data analysis module 114, which receives some or all of the ingested data 112 as input (FIG. 2, operation 206) and analyzes some or all of the ingested data 112 to generate analytical output 116 as output (FIG. 2, operation 208). As a particular example, the analytical output 116 may include worker performance output 118 representing performance of one or a plurality of workers (e.g., some or all of the workers associated with the work product data source 106). As another example, the analytical output 116 may include financial efficiency output 120 representing financial efficiency of one or a plurality of workers (e.g., some or all of the workers associated with the work product data source 106).

The worker performance output 118 and the financial efficiency output 120 are merely examples of data that may be included within the analytical output 116. The analytical output 116 may include data in addition to and/or instead of the worker performance output 118 and/or the financial efficiency output 120.

One analysis that the data analysis module 114 may perform on the ingested data 112 to generate the analytical output 116 is complexity analysis of source code. In general, complexity analysis aims to quantify the complexity of software code to predict the effort required for maintenance and updates, assess the likelihood of bugs, and evaluate the overall quality of the code. Examples of complexity measures that the data analysis module 114 may use to analyze the complexity of the ingested data 112 and to generate the analytical output 116 include any one or more of the following:
Halstead Complexity Measures: These measures are based on the number of operators and operands in the source code. They provide insights into the required effort, potential errors, and overall complexity of the code. Metrics include the Halstead Length, Volume, Difficulty, and Effort, each providing a different perspective on the complexity.
Cyclomatic Complexity: Cyclomatic complexity measures the number of linearly independent paths through a program's source code. This metric helps in understanding the testing complexity and the potential risks for bugs or failures in the code. A higher cyclomatic complexity indicates a higher number of paths and typically suggests a need for more extensive testing and maintenance.
COCOMO (Constructive Cost Model): COCOMO is an algorithmic software cost estimation model that uses the size of the code and other factors to estimate the effort and resources required for software development. This model can be particularly useful in project management for planning and allocating resources effectively.
Tiobe Index: Although not a direct measure of code complexity, the Tiobe index indicates the popularity of programming languages based on the number of skilled engineers worldwide, courses, and third-party vendors. Understanding language complexity and trends can indirectly help assess potential complexities in maintenance and scalability.

Another analysis that the data analysis module 114 may perform on the ingested data 112 to generate the analytical output 116 is sentiment analysis. Sentiment analysis is particularly valuable when applied to textual data such as customer feedback, employee communications, customer support tickets, or project management tickets. This analysis helps in understanding the emotions and sentiments expressed in the text, which can be crucial for improving products, services, and internal processes.

Performing sentiment analysis on the ingested data 112 may include extracting textual data from project management systems, such as comments, descriptions, and updates in tickets (e.g., customer support tickets or project management tickets). It may also include preprocessing the ingested data 112, such cleaning the text data by removing noise (e.g., HTML tags, special characters) and/or normalizing the text, such as converting to lowercase, removing stop words, and applying stemming or lemmatization.

The data analysis module 114 may apply any of a variety of sentiment analysis techniques, such as a lexicon-based approach, which utilizes a predefined list of words with associated sentiment scores to determine the sentiment of the text. Tools like TextBlob or VADER (Valence Aware Dictionary and sEntiment Reasoner) are commonly used for this purpose. As another example, the data analysis module 114 may use a machine learning approach, such as by training a model on a labeled dataset where the sentiments are predefined. Models could be based on algorithms like Naive Bayes, Logistic Regression, or more advanced neural networks.

The data analysis module 114 may aggregate sentiment scores to determine overall sentiment trends in customer support tickets and/or project management tickets. The data analysis module 114 may identify specific tickets with extreme sentiments (very positive or very negative).

The data analysis module 114 may store any of the output described above in the analytical output 116. Such output may include, for example, sentiment reports, dashboards showing sentiment trends over time, and alerts for tickets requiring immediate attention.

Another analysis that the data analysis module 114 may perform on the ingested data 112 to generate the analytical output 116 is theme extraction. Theme extraction is a form of text analysis that identifies and extracts common themes or topics from a collection of textual data. This may be used to understand the main subjects discussed within the data, which can provide valuable insights into recurring issues, popular features, or general sentiments among users or team members.

The data analysis module 114 may, for example, perform theme analysis on data (e.g., text) from tickets (e.g., customer support tickets and/or project management tickets), including descriptions, comments, and resolutions. The data analysis module 114 may clean (e.g., remove noise such as special characters, HTML tags, and irrelevant information) and/or normalize (e.g., standardize text by lowering case, removing stop words, and applying stemming or lemmatization to reduce words to their base forms) any such data.

The data analysis module 114 may apply one or more theme analysis techniques to the data to generate theme data. Examples of such techniques include Latent Dirichlet Allocation (LDA), Non-negative Matrix Factorization (NMF), and Term Frequency-Inverse Document Frequency (TF-IDF Analysis). For example, the data analysis module 114 may employ a vectorization approach to theme extraction, similar to methods used by embodiments of the present invention to perform code analysis. In particular, the data analysis module 114 may embed data (e.g., ticket text) into a high-dimensional vector space using a suitable embedding model. It may then apply clustering techniques, such as k-means clustering, to group these vectors. Data (e.g., tickets) that are beyond a certain distance from the centroid of their respective clusters may be discarded, focusing the analysis on data that are most representative of the central themes within each cluster.

From each cluster, the data analysis module 114 may select the top ‘n’ data elements (e.g., tickets) that are closest to the centroid. These selected data elements may be used as context to query a large language model (LLM) to suggest potential themes. The data analysis module 114 may then the embeds the suggested themes back into the same vector space and selects the theme sentence whose embedding is closest to the centroid of the cluster. This process ensures that the themes extracted are not only relevant but also central to the discussions or issues represented in the data (e.g., tickets).

As another example, the data analysis module 114 may perform theme analysis on data (e.g., text) from tickets using both n-gram and semantic vector distance. More specifically, the data analysis module 114 may first scan the text of all tickets using n-gram analysis. An n-gram is a contiguous sequence of n items from a given sample of text or speech. In this context, the data analysis module 114 may identify specific phrases (n-grams) that frequently appear in the tickets and may represent potential themes.

The data analysis module 114 may then convert each ticket into a vector using text embedding techniques. These techniques transform text into a high-dimensional vector space where semantic similarities between texts result in closer distances between their corresponding vectors.

The data analysis module 114 may group the tickets into clusters based on their vector representations. This grouping may be done using clustering algorithms such as k-means, which organize tickets into clusters such that tickets within the same cluster are more similar to each other than to those in other clusters. Within each cluster, the data analysis module 114 may calculate the semantic distance between tickets that contain the identified n-grams.

For each ticket that contains a particular n-gram, the data analysis module 114 may find all other tickets in the cluster whose semantic distance is at least as close as the distance to the ticket containing the n-gram that is most dissimilar. This means that even tickets that do not contain the exact n-gram but are contextually similar (based on their vector scores) are considered relevant to the theme.

If the number of tickets containing the specific n-gram is below a certain threshold (indicating that the phrase is not very common), the data analysis module 114 may instead find all tickets within a predefined minimum threshold of semantic similarity to the phrase itself. This ensures that even less frequently discussed themes are captured based on contextual relevance rather than mere frequency of phrase occurrence. The data analysis module 114 may consider the tickets identified in the previous step to carry the theme represented by the initial n-gram.

The data analysis module 114 may incorporate metadata from the tickets, such as the category of the ticket, priority level, or the project phase, to refine theme extraction and ensure relevance. The data analysis module 114 may aggregate and analyze the extracted themes to identify the most prevalent or critical topics discussed in the tickets. The data analysis module 114 may store any data it generates, such as identified themes, their relevance scores, and contextual analysis, in the analytical output 116.

Embodiments of the present invention may also generate and provide output representing trends in ticket opening, closing, and progress over time, over time intervals such as daily, weekly, or monthly. By presenting this data in an intuitive graphical format, such as line graphs or bar charts, embodiments of the present invention offer users a clear visual representation of a project's workflow and progress. This capability is useful for project managers and team members as it helps them understand the pace of work, identify patterns or anomalies in ticket activity, and gauge the overall project health.

For example, a sudden increase in opened tickets might indicate the initiation of a new project phase or the discovery of unforeseen issues, while an uptick in closed tickets could suggest a successful sprint of issue resolutions or task completions. Additionally, monitoring the number of tickets in progress may help in assessing workload distribution and identifying potential bottlenecks. This trend analysis not only aids in effective resource allocation and planning but also enhances strategic decision-making by providing a historical context to the current project status. Overall, the invention's ability to display ticket status trends over time is a valuable tool for optimizing project management practices and improving team productivity and responsiveness.

Another analysis that the data analysis module 114 may perform on the ingested data 112 to generate the analytical output 116 is security vulnerability identification. In particular, the data analysis module 114 may identify security vulnerabilities in source code in the work product data source 106. Identifying security vulnerabilities in source code is crucial for maintaining the integrity, confidentiality, and availability of software applications. This process may include detecting known vulnerabilities that could potentially be exploited by malicious entities.

Identifying security vulnerabilities may include extracting source code and/or other data from the work product data 106. The data analysis module 114 may perform any one or more of the following to identify actual or potential security vulnerabilities in the extracted data:
analyze the extracted code for syntactic correctness and semantic errors that could lead to vulnerabilities;
use pattern matching techniques to identify code segments that match known vulnerability patterns;
execute parts of the application in a controlled environment to identify vulnerabilities that only appear during execution, such as runtime errors and memory leaks;
analyze the libraries and dependencies used in the source code to identify any that are outdated or have known vulnerabilities;
check the configuration settings of the source code and its environment to ensure they comply with security best practices;
ensure the code adheres to industry standards and regulations which can mitigate the risk of security vulnerabilities.

Any output generated by the data analysis module 114 as a result of identifying security vulnerabilities may be stored in the analytical output 116. Data representing such security vulnerabilities may include for example, data identifying such vulnerabilities, their severity, and their potential impact.

Another analysis that the data analysis module 114 may perform on the ingested data 112 to generate the analytical output 116 is to perform financial transaction outlier detection on financial data within the financial data source 108. Outlier detection is a statistical technique used to identify data points that deviate significantly from the norm, which can indicate errors, fraud, or anomalies that require further investigation.

The data analysis module 114 may retrieve some of all of the data from the financial data source 108. The data analysis module 114 may perform any of a variety of statistical analyses on the retrieved data. For example, the data analysis module 114 may calculate basic statistics, such as mean, median, standard deviation, and interquartile range (IQR) to understand the distribution of transaction values. The data analysis module 114 may perform any of a variety of contextual analyses on the retrieved data. For example, the data analysis module 114 may perform temporal analysis on the retrieved data to look for unusual patterns over time, such as a sudden increase in transaction volume or size, and/or perform a categorical analysis on the retrieved data to analyze transactions by categories (e.g., vendor, department) to identify outliers within specific groups.

The data analysis module 114 may use any of a variety of machine learning techniques as part of the outlier detection process. For example, the data analysis module 114 may use clustering algorithms, such as K-means or DBSCAN, to group similar transactions and identify those that do not fit into any cluster. As another example, the data analysis module 114 may employ one or more models specifically designed for anomaly detection, such as Isolation Forest or Autoencoders, which are effective in identifying outliers in complex datasets.

The data analysis module 114 may incorporate business-specific rules to refine outlier detection, such as thresholds for acceptable transaction sizes or frequencies based on historical data or industry standards.

Any results of outlier detection generated by the data analysis module 114 may be stored in the analytical output 116. Such output may include, for example, detailed reports, visualizations of outlier data points, and alerts for transactions that require immediate attention.

As mentioned above, the analytical output 116 may include worker performance output 118. In general, the system 100 may use the worker performance output 118 to evaluate and quantify the performance of individual workers, such as software developers. The worker performance output 118 may be used, for example, to assess productivity, impact, and profitability of workers within an organization. The worker performance output 118 may take any of a variety of forms, and the data analysis module 114 may generate the worker performance output 118 based on the ingested data 112 in any of a variety of ways.

For example, the worker performance output 118 may include, for each of a plurality of workers (e.g., software developers), corresponding worker performance output (e.g., a single numerical score) which represents performance of that worker. The worker performance output (e.g., score) may differ among different workers. As a result, the worker performance outputs for different workers within the worker performance output 118 may be used to assess the relative performance (e.g., impact, productivity, and/or profitability) of different workers in any of a variety of ways, some of which are described below.

For example, the data analysis module 114 may identify, within the ingested data 112, work product corresponding to each of a plurality of workers. As one example, the work product data source 106 may include metadata which identifies, for each of a plurality of work products, which worker or workers were responsible for contribution to (e.g., creating and/or modifying) that work product. As a particular example, the work product data source 106 may include data from a source code management system (e.g., Github) which identifies which software developers contributed to different units of source code within the work product data source 106. Identifying which software developers contributed to which sections of source code may involve, for example, analyzing commit logs, pull requests, and other version control data to accurately attribute code contributions to the correct developer. The metadata indicating the contributions of software developers to source code may be obtained from the work product data source 106, generated by the data sources module 110 based on data obtained from the work product data source 106, or any combination thereof.

Metadata that links software developers to their contributions in the source code may take various forms, each offering unique benefits depending on the complexity of the project, the tools used, and the specific needs for tracking and analysis. Here are some common forms of metadata and the advantages they provide:
Commit IDs and Author Tags: Each piece of code checked into a version control system like Git is associated with a commit ID. Alongside, an author tag is used to record the identity of the developer who made the commit. This form of metadata is straightforward and tightly integrated with version control systems, making it easy to track changes back to specific developers. It supports accountability and simplifies code review processes by clearly identifying the origin of each change.
Blame Maps: Version control systems such as Git offer a ‘blame’ feature that shows line-by-line authorship of a file, indicating who last modified each line and in which commit. Blame maps are particularly useful for debugging and understanding the evolution of specific code segments. They allow teams to quickly identify who to consult about particular code functionalities or issues, enhancing team collaboration and efficiency.
Digital Signatures: Code contributions can be digitally signed by the contributing developer, using cryptographic techniques to verify the authenticity and integrity of the contribution. Digital signatures provide a high level of security by preventing unauthorized changes and ensuring that the code has not been tampered with since it was signed. This is crucial in environments where code security and integrity are paramount.
Annotation Tags in Documentation: Source code and accompanying documentation may include annotation tags that explicitly name the developers responsible for writing or overseeing specific modules or functions. This form enhances the documentation by providing context about the development and maintenance history of the code. It is particularly useful for new team members who are getting acquainted with the project, as it directs them to the right individuals for queries about specific code sections.
Code Review Records: Integrated development environments (IDEs) and code review tools may maintain records of who reviewed what code, including comments and approvals. This metadata form fosters a collaborative review process and enhances code quality by ensuring that multiple eyes have scrutinized each part of the code. It also helps in maintaining a history of discussions and decisions made during the code review process.
Task and Issue Tracking Integration: Linking code commits to specific tasks or issues in a project management tool, where each task or issue is assigned to one or more developers. This integration ensures that code changes are traceable to specific project requirements or bug fixes, facilitating better project management and prioritization. It also helps in evaluating developer productivity and contribution in the context of project milestones.
Change Tickets: For each change made in the code, a change ticket is created in a configuration management database, detailing what was changed, why, and by whom. Change tickets provide a formal and detailed record of modifications, supporting compliance with regulatory standards and aiding in audit trails. This form is particularly beneficial in regulated industries where documenting every change is mandatory.

Any such worker-identification information may be copied into or otherwise reflected in the ingested data 112 that the data analysis module 114 uses to generate the worker performance output for each of a plurality of workers in the worker performance output 118. As a result, the data analysis module 114 may use the ingested data 112 to identify, for any particular worker (e.g., software developer), the unit(s) of source code in the work product data source 106 that were created or otherwise contributed by that particular software developer.

Embodiments of the present invention may link code commits to specific tickets in any of a variety of ways. For example, embodiments of the present invention may use a common identifier or tagging system across both the project management system (in which tickets are created and managed) and the version control system (in which commits are made and stored). For example, each ticket may have a unique ID that must be referenced in the commit messages when developers check in their code.

Alternatively, for example, embodiments of the present invention may use any of a variety of techniques to automate linking between code commits and specific tickets in any of a variety of ways. For example, embodiments of the present invention may implement pre-commit hooks in the version control system that require developers to include a ticket ID from the project management system in their commit messages. This may be enforced through regular expressions that validate the format of commit messages. After a commit is made, automated scripts may parse the commit message, extract the ticket ID, and automatically link the commit to the corresponding ticket in the project management system.

As another example, embodiments of the present invention may use a combination of manual linking and Ul enhancements to link code commits to tickets. For example, both the project management system and version control system may offer user-friendly interfaces that allow developers and project managers to manually link or unlink tickets and commits. This may be facilitated by dropdown menus or search options to find and select related tickets or commits. An audit trail may be maintained for manual linking activities to track who linked a ticket and a commit and when.

As yet another example, embodiments of the present invention may use machine learning and/or natural language processing (NLP) techniques to analyze the text in tickets and commit messages. Based on the analysis, embodiments of the present invention may suggest potential links which users can confirm or adjust.

Regardless of the method used to create links between code commits and tickets, once such links have been created, embodiments of the present invention may use such links to analyze and generate output representing the difficulty of a particular task (such as writing of particular code implementing a particular feature) that is related to one or more tickets and one or more code commits, using the generated links. Consider an example in which a user asks, “How difficult was <Feature X> to implement?”, where <Feature X> describes a feature that has been implemented in particular source code. Embodiments of the present invention may receive such a question and process source code, ticket data, code commit data, and links between the ticket data and the code commit data, to produce output representing a difficulty of implementing <Feature X>. Embodiments of the present invention may provide such output in any form, such as a single number representing the difficulty of implementing <Feature X>, or a textual description, such as: “Ten people worked on 15 tickets related to <Feature X> over 5 months. Of those 15 tickets, 5 were linked to code commits with a total of 1,000 lines of code, a Halstead complexity of 5,000, and a developer impact score of 950. As this indicates, <Feature X> was very difficult to implement.”

To compute such a difficulty of implementing a feature, embodiments of the present invention may identify all tickets related to that feature, such as by using semantic vector searches, keyword searches, tag filters, and/or other searches. For each ticket identified, embodiments of the present invention may use the previously-generated links between tickets and code commits to retrieve the code commits that are linked to the identified tickets.

Embodiments of the present invention may identify, based on the identified tickets and linked commits, the number of unique developers who have worked on the linked tickets and commits. This provides an indication of the team size involved in the development of the feature. Embodiments of the present invention may also compute the total number of identified tickets and the time span from the opening of the first ticket to the closing of the last ticket related to the feature in question. This helps in assessing the duration of the development effort.

For each linked commit, embodiments of the present invention may: (1) aggregate code metrics, such as the total number of lines of code added or modified; and/or (2) compute code complexity metrics, such as Halstead complexity, for the changes made in these commits.

Embodiments of the present invention may use any of the techniques disclosed herein to compute or retrieve the worker impact scores for the developers associated with the commits. Embodiments of the present invention may also compute an aggregate impact score for all developers involved, providing a composite measure of the overall quality and effectiveness of the development work on the feature in question.

All of the collected data-such as the number of developers, number of tickets, duration of development, total lines of code, code complexity, and worker impact scores-may be integrated to form a comprehensive overview of the development effort. Based on the aggregated data, embodiments of the present invention may assess and generate output representing the difficulty of implementing the feature in question. For example, a high number of tickets, high code complexity, and high worker impact scores combined with a long development duration and involvement of many developers might indicate that the feature was quite difficult to implement. Embodiments of the present invention may output the difficulty to a user through a user interface, report, or as part of an automated response to a query.

The data analysis module 114 may generate, based on some or all of the ingested data 112 (such as parts of the ingested data 112 that were obtained and/or generated from the work product data source 106), data representing a measure of the “impact” of each of some or all of the workers (e.g., software developers), also referred to as the worker's “impact score” (whether or not the impact measure takes the form of a single numerical value) As will be described in more detail below, a worker's impact score differs from conventional measures of worker productivity. Instead, a worker's impact score may be calculated based on a combination of factors that measure the worker's quantity, quality, and permanence of contributions to the work product (e.g., source code) in the work product data source 106.

As will further be described in more detail below, a worker's impact score provides a quantitative measure of the worker's productivity and effectiveness. It may be used, for example, in performance reviews to assess individual contributions in a clear and standardized manner. Understanding the impact of individual workers can help management make informed decisions about resource allocation. For example, for investors or potential acquirers, worker impact scores provide insights into the human capital of a company. A team with high average scores might indicate a strong, effective development team, which could be a valuable asset and influence investment decisions.

Examples of ways that the data analysis module 114 may generate an impact score for a single worker will now be described. It should be understood that the data analysis module 114 may use such techniques to calculate an impact score for some or all of the plurality of workers whose work product data is obtained from the work product data source 106. Furthermore, although impact scores may take the form of individual numerical values, they may alternatively take the form of other kinds of data structures, including structures that contain multiple values.

As part of generating the impact score for an individual worker, the data analysis module 114 may generate, based on the work product (e.g., source code) associated with that particular worker (e.g., software developer), a summary metric of the worker's contribution to that work product. The summary metric may be calculated based on measures of the quantity, quality, and permanence of the worker's contributions to the work product. For example, the data analysis module 114 may calculate the summary metric for a particular worker by identifying and/or calculating measures of the worker's quantity of contributions to the work product, quality of contributions to the work product, and permanence of contributions to the work product, and calculating the worker's impact score based on those measures of quantity, quality, and permanence.

As this implies, the summary metric may consider not only the volume of contributions made by each worker, but also the quality and the complexity of the work involved in those contributions. The data analysis module 114 may generate such a summary metric for each of a plurality of workers and include those summary metrics for the plurality of workers in the worker performance output 118.

As an example of such a summary metric, the data analysis module 114 may calculate or otherwise identify the total number of lines of code a particular developer has added to (insertions) and removed from (deletions) a specific unit of source code, such as a file.

To account for the pace at which the source code changes, which can vary widely between projects or even within different parts of the same project, the data analysis module 114 may consider the rate of change of the unit of source code. The rate of change may, for example, be measured as the number of lines added or deleted to/from the source code unit (e.g., file) per day across all developers. It provides a context for the insertions and deletions, offering insight into how active the codebase is and how significant the developer's changes are relative to the overall project activity. The data analysis module 114 may divide the sum of the particular developer's insertions and deletions by the source code unit's rate of change, to produce a quotient.

The data analysis module 114 may also incorporate a measure of the complexity of the code to adjust the performance score, reflecting not just the quantity of work done but also its difficulty. Complexity metrics, such as Halstead complexity, consider various factors such as the number of operators and operands in the code, which help in assessing the intellectual effort required to understand and modify the code. Higher complexity often indicates more challenging and potentially impactful work. The data analysis module 114 may compute an impact score by multiplying the quotient described above by a measure of complexity of the source code unit (e.g., file).

$$Impact Score = \frac{Sum of Insertions and Deletions in a Source Code Unit}{Rate of Change} \times Complexity Measure$$

The data analysis module 114 may calculate such an impact score for each of a plurality of changes (deltas) for a single worker, thereby calculating a plurality of impact scores for that single worker. The data analysis module 114 may calculate such a plurality of impact scores at a particular time (e.g., based on changes already made) and/or over time, as the worker makes additional changes to the source code. The result is an aggregate impact score for the worker.

In short, the delta impact scores are immediate, specific scores assigned to individual changes made by software developers. They reflect the value and quality of single contributions (insertions and deletions) to the codebase. In contrast, the aggregate impact score for each developer is an aggregated measure that provides a broader view of a developer's overall performance. It integrates the scores of multiple changes (deltas) to give a comprehensive assessment of a developer's contributions over a period of time and/or across a project. In practice, this means that while a developer might have several individual deltas with varying scores (some high due to complex but necessary changes, others lower perhaps due to simpler tweaks), the developer's aggregate impact score (which is an example of the per-developer “summary metric” mentioned earlier) will reflect the developers' overall effectiveness and efficiency as a contributor to the project. This dual-level analysis allows requesters to recognize both impactful individual contributions and consistent performance over time.

The description above explains how the data analysis module 114 may compute a summary metric (e.g., aggregate impact score) for a single software developer. The data analysis module 114 may use the same techniques to compute a summary metric (e.g., aggregate impact score) for each of a plurality of software developers, thereby computing a plurality of summary metrics (e.g., aggregate impact scores) for the plurality of software developers.

The data analysis module 114 may use the summary metrics of the target's developers (i.e., developers associated with the work product data in the work product data source 106) to compare the target's developers to benchmarks derived from applying the same scoring algorithms (delta scores and summary metrics) to other source code (e.g., the most popular open source repositories), thereby allowing the data analysis module 114 to percentile rank software developers by their summary metrics and delta scores.

For example, the data analysis module 114 may gather data from external sources of source code, such as one or more popular open source repositories. The data analysis module 114 may use the techniques described above to calculate summary metrics for each of a plurality of software developers associated with the external data from open source repositories. This ensures that the benchmarks are directly comparable to the summary metrics calculated for the target's developers. The data analysis module 114 may compute one or more benchmarks based on the summary metrics that were calculated from the open source data. Calculating such benchmarks may include, for example, calculating average scores, median values, or other statistical measures, based on the open source data, that best represent typical performance standards in the broader software development community.

The data analysis module 114 may compare the summary metrics and delta scores of the target's developers against the established benchmarks. This analysis identifies how each target developer's performance measures up to external standards. This may include adjusting for any differences in project scope, complexity, and scale between the target's projects and those in the open source repositories to ensure a fair comparison.

The data analysis module 114 may rank each of the target developer's performance by calculating the percentile relative to the benchmarks. This may include sorting the combined set of scores (both internal and external) and determining the position of each internal score within this distribution. For example, if a developer's score is better than 90% of the benchmark scores, they would be placed in the 90th percentile. The data analysis module 114 may assign a percentile rank to each developer based on both their summary metrics and their delta scores. This dual-ranking system provides a nuanced view of performance, highlighting both overall contributions and specific impactful changes. The data analysis module 114 may generate detailed reports for each developer that show their percentile rankings and how they compare to the benchmarks.

Any of the data disclosed above, such as the internal and external summary metrics, summary metrics, benchmarks, and benchmark comparisons (e.g., percentile ranks), may be included within the worker performance output 118, and thereby reflected within the synthesized output 124.

As mentioned above, the analytical output 116 may include financial efficiency output 120. The financial efficiency output 120 provides critical insights that are particularly valuable to investors or potential acquirers of a target company. These stakeholders are primarily interested in understanding the financial health, operational efficiency, and potential for future profitability of the company they are considering investing in or acquiring. The financial efficiency output 120 offers detailed insights into how effectively the target manages its resources. This helps investors and acquirers assess the operational risks associated with inefficient resource management. Furthermore, by analyzing the financial efficiency of a target company, investors can make more informed decisions about the company's valuation. Efficient financial management often correlates with a stronger, more stable financial position, enhancing the company's value. The financial efficiency output 120 can indicate the potential for future earnings and growth, which are critical components of a company's valuation during investment or acquisition discussions.

The data analysis module 114 may generate the financial efficiency output 120 in any of a variety of ways, such as in the following way. The data analysis module 114 may ingest data from the financial data source 108, which may include, for example, Human Resources Information System (HRIS) and/or payroll data. This data provides detailed information about each developer's salary, bonuses, and other compensation-related metrics.

The data analysis module 114 evaluates each of the target's developer's performance based on that developer's contributions to projects, quality of work, and overall productivity. The data analysis module 114 converts this performance data into a percentile ranking, indicating how a developer ranks in comparison to their peers within the target and/or against industry benchmarks. Similarly, the data analysis module 114 may analyze each developer's compensation data to determine their financial percentile. This percentile reflects how a developer's salary compares to the salaries of other developers within the same organization or industry.

More specifically, the data analysis module 114 may, for each of the target's developers: (1) calculate the percentile of that developer's aggregate impact score among all of the target developers' aggregate impact scores; (2) calculate the developer's salary percentile; and (3) compare the developer's aggregate impact score percentile (also referred to herein as the developers' “performance percentile”) with the developer's financial percentile to produce a comparison output for that developer. More specifically, the data analysis module 114 may subtract the developer's salary percentile from the developer's performance percentile to produce the comparison output for that developer. This difference provides a preliminary measure of how well-aligned a developer's compensation is with their performance.

The data analysis module 114 may multiply this comparison output (e.g., difference) by a factor, such as ten. This step amplifies the difference, making the subsequent calculations more sensitive to discrepancies between performance and compensation.

The data analysis module 114 normalizes the result of the multiplication, such as by using a sigmoid function. This function is particularly useful because it compresses the output range to between 0 and 1, ensuring that the final scores are scaled appropriately, and mitigating the effect of extreme values or outliers.

The data analysis module 114 multiplies the output from the sigmoid function by a factor (e.g., 100) to scale it up to a more interpretable range, typically 0 to 100. This final score represents the financial efficiency score for each developer.

The financial efficiency output 120 generated by the data analysis module 114 offers a nuanced view of financial efficiency at the individual developer level. By systematically comparing performance and compensation percentiles, and normalizing these comparisons into a standardized score, the financial efficiency output 120 helps the target and requester to identify discrepancies, reward performance appropriately, and ensure that compensation strategies are aligned with actual productivity and contribution levels. This process is crucial for maintaining fairness, motivating employees, and optimizing financial expenditure on human resources.

In particular, each developer's financial efficiency score is designed to evaluate the alignment between a developer's compensation (salary percentile) and their performance (performance percentile). The score is particularly insightful when assessing whether a developer is being paid commensurately with their contributions to the organization. To understand this, consider that a developer's salary percentile represents where a developer's salary falls relative to their peers. For example, a salary percentile of 70 means the developer earns more than 70% of their peers. Consider also that a developer's performance percentile indicates how a developer's performance compares to their peers. A performance percentile of 80 suggests that the developer performs better than 80% of their peers.

Recall now that calculating a developer's financial efficiency score includes subtracting the developer's salary percentile from the developers' performance percentile. If a developer's salary percentile is lower than their performance percentile, the subtraction (performance percentile-salary percentile) results in a positive number. For example, if the performance percentile is 80 and the salary percentile is 70, the difference is +10. This scoring system, therefore, effectively recognizes developers who are contributing more to the organization relative to what they are being paid. A higher financial efficiency score highlights developers who may be undervalued in terms of compensation, suggesting they are providing excellent value for the cost. Conversely, a lower financial efficiency score points out developers who are being paid too much relative to their performance. An investor or other requestor of information from the target will find both of these kinds of information to be valuable for making decisions about whether and how much to invest in the target, and whether to make staffing and/or compensation changes among the target's developers.

The system 100 also includes an output synthesis and reporting module 122, which receives some or all of the analytical output 116 as input (FIG. 2, operation 210), and generates synthesized output 124 as output (FIG. 2, operation 212). As will be described in more detail below, the synthesized output 124 may include any of a variety of output, such as one or more reports and/or one or more dashboards, based on the analytical output 116 (e.g., the worker performance output 118 and/or the financial efficiency output 120). The synthesized output 124 may, for example, take the form of visual output provided to a user of the system 100.

For example, embodiments of the present invention may compute company-wide performance metrics based on the ingested data 112, such as data from the work product data sources 106 and/or the financial data sources 108. Any such company-wide performance metrics may be included in the synthesized output 124.

For example, embodiments of the present invention may calculate company-wide metrics by aggregating and analyzing data from individual software developers and integrating this data with broader organizational metrics. This holistic approach allows embodiments of the present invention to provide insights into overall effort, average ability, thematic trends, and other key performance indicators across the company. For example, to compute overall effort and average ability, the system 100 may collect data on each developer's activities, such as lines of code written, tasks completed, and hours logged. This data may be aggregated to calculate the total effort expended by the development team over a given period. To assess average ability, the system 100 may analyze metrics such as the complexity of tasks each developer handles, the speed of task completion, and the quality of outputs (e.g., code quality assessments, bug rates). By averaging these metrics across all developers, the system 100 may provide an overall view of the team's ability.

The system 100 may extract common themes from project management tickets and developer communications in order to identify prevalent issues or focus areas within the company. The system 100 may track the number of tickets opened, closed, and in progress over time, categorizing them by theme. This allows the system 100 to report on trends, such as increasing focus on certain types of features or issues, providing insights into shifting company priorities.

The system 100 may calculate the total daily developer impact by aggregating individual impact scores, which consider factors like code complexity, innovation, and problem-solving. This metric helps determine if the codebase is actively maintained or if activity is declining. Total defects across the company may be tracked and analyzed to assess the overall quality of the software being developed. This includes identifying common sources of defects and areas that may require additional focus or resources.

The system 100 may calculate Errors Per Million lines of code (EPM) by aggregating error data across all projects and normalizing this by the total amount of code written. This provides a standardized measure of code quality. The system 100 may computed company-wide Halstead Complexity metrics by analyzing all codebases within the company. This helps in understanding the overall complexity of the software developed and can guide decisions on maintenance and scalability.

Any of the metrics described above may be included within the synthesized output 124. Although such metrics may be computed as company-wide aggregates, they may alternatively or additionally be computed and displayed on a per-committer, per-project, and/or per-repository basis.

Embodiments of the present invention may also compute, store (e.g., within the synthesized output), and display any of a variety of data representing technical and/or financial aspects of a company's operations, including conventional metrics such as payroll and Diversity, Equity, and Inclusion (DEI) metrics, as well as broader financial information, such revenue and profit. This capability allows embodiments of the invention to offer a holistic view of the company's performance and workforce dynamics.

The synthesized output 124 may, for example, include one or more dashboards. In general, a dashboard is a visual interface that aggregates and displays information and data in an easy-to-understand format, often using charts, graphs, and summaries. Dashboards are designed to provide users with a quick, clear view of key performance indicators (KPIs), metrics, and other important data at a glance. The primary purpose of a dashboard is to enable quick decision-making by presenting data in a highly interactive and accessible manner. Dashboards are commonly used in business environments to monitor the health and performance of the organization, track operational workflows, or provide insights into customer interactions and market trends.

Dashboards within the synthesized output 124 may include, for example, any one or more of the following, in any combination:
Key Metrics and Indicators: Display key metrics such as worker performance scores (worker performance output 118) and financial efficiency ratings (financial efficiency output 120). These metrics help in assessing the productivity and cost-effectiveness of workers or departments within the organization.
Charts and Graphs: Use various types of charts (e.g., bar, line, pie) to represent data visually. For instance, a line chart could show trends over time in worker productivity, while a bar chart could compare the financial efficiency of different departments.
Real-Time Data Feeds: Incorporate real-time data updates to reflect the most current state of affairs. This is crucial for operational environments where conditions change rapidly, and up-to-date information is necessary for effective decision-making.
Interactive Elements: Include filters, sliders, and dropdown menus that allow users to customize the view according to their specific needs or interests. For example, a user could filter the financial efficiency data to view only those departments that fall below a certain threshold.
Predictive Analytics and Forecasts: Integrate predictive analytics models that use historical data to forecast future trends. This could be particularly useful for anticipating changes in worker performance or financial metrics and planning accordingly.
Alerts and Notifications: Set up alerts to notify users when certain thresholds are reached or anomalies are detected. For example, if a worker's performance drops suddenly, the dashboard could trigger an alert to notify the relevant supervisors.
Customizable Reports: Provide options to generate customizable reports based on the data displayed on the dashboard. These reports can be tailored to the needs of different stakeholders, providing them with detailed insights into specific areas of interest.

The output synthesis and reporting module 122 may calculate one or more benchmarks, such as one or more benchmarks related to the workers associated with the data in the work product data source 106. Benchmarks serve as standard points of reference against which individual performances can be measured and compared. This capability is crucial for assessing productivity, identifying areas for improvement, and fostering a competitive and efficient work environment.

Examples of benchmarks that may be useful for the output synthesis and reporting module 122 to calculate in the context of software developer productivity include any one or more of the following, in any combination:
Lines of Code (LOC): Measures the number of lines of code written by a developer within a specific period.
Commit Frequency: Tracks the number of commits a developer makes to a version control system.
Code Quality Metrics: Includes measures such as bug rates, code complexity, and adherence to coding standards.
Feature Completion Rate: Measures how quickly and effectively a developer completes assigned features or tasks.
Peer Review Feedback: Involves qualitative assessments from peers, such as code review scores and collaborative feedback.
Customer Satisfaction: Measures the satisfaction level of end-users or clients with the software solutions provided.

The output synthesis and reporting module 122 may calculate any such benchmarks based on data in the work product data source 106, including data across multiple software developers. For each developer, the output synthesis and reporting module 122 may calculate specific metrics that represent how that developer's performance compares to the established benchmarks. This may, for example, be in the form of indices, scores, or percentile rankings.

The resulting synthesized output 124 may, for example, include any of a variety of reports and/or visualizations that include one or more of the following, in any combination:
Benchmark Metrics: Displays the benchmarks for each metric, providing a clear standard for comparison.
Individual Performance Metrics: Shows how each developer's performance measures up against the benchmarks.
Rankings and Comparisons: Offers rankings or direct comparisons among developers, which can motivate improvements and recognize top performers.

The dashboard generated by the output synthesis and reporting module 122 within the synthesized output 124 may be generated and displayed based on a particular state of the analytical output 116. The system 100 may update the dashboard based on an updated state of the analytical output 116 or based on updated algorithms and/or user preferences for generating the synthesized output 124. The output synthesis and reporting module 122 may update the synthesized output 124 automatically and repeatedly over time in response to any such changes to the analytical output 116, algorithms used by the output synthesis and reporting module 122, and user preferences.

Once the synthesized output 124 has been generated, the target reviews the synthesized output 124 and decides whether to approve it. If the target decides not to approve the synthesized output 124, such as because of problems with accuracy or security concerns, the target may make any of a variety of changes to the underlying data that was used to generate the synthesized output 124 and/or to the synthesized output 124 itself until the target is satisfied with the synthesized output 124. Eventually, the target approves the synthesized output 124 for provision to the requester.

This process of reviewing, modifying, and approving the synthesized output 124 ensures the accuracy, security, and relevance of the information before it is shared with requesters, such as stakeholders or decision-makers. This iterative process allows the target, typically the entity or department within an organization responsible for the data, to maintain control over the quality and confidentiality of the output.

More specifically, once the output synthesis and reporting module 122 has generated the synthesized output 124, the target performs an initial review of the synthesized output 124. The review may, for example, focus on assessing the accuracy of the information, the relevance of the data presented, and the security of the content, ensuring that sensitive information is appropriately handled.

If the target identifies issues such as inaccuracies, missing data, or security concerns, they pinpoint the specific elements that need adjustment. The target may return to the underlying data that was used to generate the synthesized output 124. This may involve correcting data entries, updating data sources, or enhancing data security measures. Adjustments might also be made directly to the synthesized output 124. This may include reconfiguring the data presentation, altering the layout of reports or dashboards, or revising the analytical models used. After modifications are made, the updated synthesized output 124 is reviewed again by the target to ensure that all concerns have been adequately addressed. This cycle may repeat multiple times until the target is satisfied with the outcome.

Once the target is satisfied that the synthesized output 124 meets all criteria for accuracy, security, and relevance, the target approves the synthesized output 124 for provision to the requester. The system 100 provides the approved version of the synthesized output 124 to the requester.

When the target approves of the synthesized output 124, the system 100 grants the requester with access to the synthesized output 124. Granting the requester with access to the synthesized output 124 may take any of a variety of forms. For example, the system 100 may provide the requester with access to a snapshot (e.g., a specific state) of the synthesized output 124, such as in the form of a dashboard that does not update. In such a case, the system 100 may update the version of the synthesized output 124 that is provided to the target over time, such as based on changes to the data in the plurality of data sources 104, changes in the analytical output 116, and/or changes in the methods used by the data sources module 110 and/or the data analysis module 114, but not update the version of the synthesized output 124 that is provided to the requester. Updates to the synthesized output 124 may be provided the requester only in response to approval from the target. Such an embodiment provides the target with control over the version of the synthesized output 124 that is provided to the requester, while enabling the target to generate and view the most updated version of the synthesized output 124 at any time. This form of access is particularly useful when historical accuracy is essential, or when the data needs to remain consistent for audit purposes.

Alternatively, the system 100 may make updates to the synthesized output 124 available to the requester, such as in the same way as such updates are made available to the target. For example, the system 100 may provide both the target and the requester with access to a dynamic dashboard that is updated based on updates to the synthesized output 124. Providing dynamic access to the requester can be beneficial for situations where ongoing monitoring and timely data are crucial.

The target may share the synthesized output 124 (including one or more dashboards) with one or more requesters. If the target shares the synthesized output 124 with multiple requesters, the system 100 need not repeat the entire process described above for each such requester. Instead, the system 100 may perform functions such as retrieving data from the plurality of data sources 104, generating the ingested data 112, generating the analytical output 116, and generating the synthesized output 124 only once. The system 100 may then grant access to the synthesized output 124 to one or more requesters, without the need to repeat the data processing steps. The system 100 may, however, customize any of the functions disclosed herein for different requesters, such that different instances of the synthesized output 124 may be generated for and shared with different requesters.

The entire process need not be repeated for each requester. Instead, once the dashboard has been created, it may be shared with one or more requesters without the need to go through all of the steps needed to create the dashboard for each requester.

Although the description above refers to received work product data about individual workers from the work product data sources 106, embodiments of the present invention may also receive any of a variety of information about groups of workers, such as an entire division or company. Such data, referred to herein as “company-wide data” (even if it represents data for a group of workers that is smaller than a company) may, for example, be received from one or more inventory systems, order management systems, and/or e-commerce systems.

Embodiments of the present invention may use such company-wide data within the methods disclosed herein in any of a variety of ways. For example, embodiments of the present invention may perform financial analysis based on company-wide data. For example, embodiments of the present invention may use data from inventory and order management systems to generate insights into the costs associated with maintaining and distributing products. Embodiments of the present invention may analyze the financial efficiency of software developers not just in terms of salary and compensation but also in how effectively their work contributes to reducing operational costs. As another example, embodiments of the present invention may use e-commerce data, which typically includes sales figures, to correlate specific software developments or improvements with changes in sales performance. This allows embodiments of the present invention to measure the direct impact of software developers on revenue generation, providing a more comprehensive view of their economic contribution to the company.

Embodiments of the present invention represent a significant advancement over prior art techniques by integrating technical performance metrics with financial data to create a comprehensive evaluation of software developers' financial efficiency. This integration allows for a more holistic assessment of a developer's value to an organization, factoring in both their productivity and the cost of their labor.

Traditional systems primarily focus on measuring technical performance metrics such as the Halstead or COCOMO metrics, which evaluate aspects like the complexity and effort involved in software development. These systems lack the capability to integrate these technical metrics with financial data, such as salaries or other compensation-related expenses. Consequently, they can only provide a partial view of a developer's contribution, centered around productivity or code complexity.

In contrast, embodiments of the present uniquely combine these technical metrics with financial data from systems like HRIS (Human Resources Information System). This allows embodiments of the invention not only to assess the quality and quantity of work performed by developers but also to evaluate the cost-effectiveness of these contributions. By correlating a developer's productivity metrics with their compensation data, embodiments of the invention can generate financial efficiency metrics. These metrics provide insights into whether a developer's output justifies their cost to the company.

Embodiments of the present invention may, for example, correlate identifiers such as email addresses from different systems (e.g., GitHub and HRIS). This correlation enables embodiments of the invention to accurately link the technical contributions of a developer (e.g., commits in GitHub) to their financial records (e.g., salary data in HRIS). This linkage is crucial for accurately calculating the cost of software development per developer and assessing the financial return on investment in human capital.

Embodiments of the invention may calculate financial efficiency by comparing the cost of a developer (salary percentile) to their productivity (performance percentile). For instance, if a developer's performance is high relative to their cost, they would have a high financial efficiency score. This metric is particularly valuable for investors when making decisions about whether and how much to invest in a target company. In particular, the financial efficiency scores generated by embodiments of the present invention enhance the investor's understanding of the target's operational efficiency, talent utilization, and overall financial health, which are crucial for making informed investment decisions.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention include features that leverage the processing power, data handling capabilities, and automation provided by computer technology, making them inherently rooted in computer technology and impractical to perform manually or mentally by humans. As one example, embodiments of the invention automatically ingest and integrate data from multiple sources, such as HRIS, payroll systems, and source code management systems like GitHub. This process involves handling large volumes of data and different data formats that are beyond the scope of manual processing. As another example, embodiments of the invention apply complex algorithms to analyze the ingested data. This includes the calculation of financial efficiency scores, performance metrics, and other analytical outputs based on sophisticated mathematical models like the sigmoid normalization and percentile ranking methods. These calculations involve handling large datasets and performing operations that require significant computational power, which cannot be feasibly done manually. As yet another example, embodiments of the invention provide real-time monitoring and continuously updated dashboards that display the analysis results. These dashboards reflect changes in the data as they occur, offering up-to-date insights that are crucial for timely decision-making. The process of continuously gathering, processing, and displaying data in real-time is only feasible with the use of computer systems and would be impossible to replicate manually or mentally without significant delays and inaccuracies.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

1. A method performed by at least one computer processor executing computer program instructions stored on at least one non-transitory computer-readable medium, the method comprising:
(A) generating ingested data, comprising:
(A)(1) installing an agent software application on a local computer system of a work product data source and using the agent software application to retrieve work product data from the work product data source;
(A)(2) processing the work product data from the work product data source, the work product data comprising source code and associated metadata, wherein the associated metadata links each of a plurality of contributions within the source code to at least one of a plurality of software developers who are responsible for that contribution;
(A)(3) processing financial data from a financial data source, the financial data containing compensation data related to the plurality of software developers;
(B) analyzing the ingested data to generate worker performance metrics based on the contributions of the plurality of software developers to the source code, comprising generating, for each software developer D in the plurality of software developers, a corresponding summary metric, comprising:
(B)(1) identifying a quantity of the software developer D's contribution to the source code;
(B)(2) identifying a quality of the software developer D's contribution to the source code, comprising:
(B)(2)(i) generating high-dimensional vector embeddings of textual data associated with the software developer D's contribution to the source code; and
(B)(2)(ii) applying clustering techniques to the high-dimensional vector embeddings to identify quality characteristics of the software developer D's contribution to the source code;
(B)(3) identifying a permanence of the software developer D's contribution to the source code; and
(B)(4) computing the summary metric for the software developer D based on the identified quantity, quality, and permanence of the software developer D's contribution to the source code, wherein computing the summary metric comprises computing a Halstead complexity of the source code;
(C) analyzing the ingested data to generate financial efficiency metrics, comprising comparing the worker performance metrics with the compensation data to generate an assessment of the cost-effectiveness of each of the plurality of software developers' contributions to the source code, wherein generating the financial efficiency metrics comprises calculating a financial efficiency score for each of the plurality of software developers, comprising:
computing a performance percentile for each of the plurality of software developers, comprising calculating the performance percentile based on a comparison of the software developer's contributions to the source code against contributions from a peer group;
computing a compensation percentile for each of the plurality of software developers, comprising calculating the compensation percentile based on a software developer's total compensation relative to a total compensation of the peer group; and
for each of the plurality of software developers, subtracting the software developer's compensation percentile from the software developer's performance percentile to produce a preliminary financial efficiency score for the software developer;
(D) synthesizing the worker performance metrics and the financial efficiency metrics into an analytical output; and
(E) generating a synthesized output based on the analytical output, wherein the synthesized output represents, for each software developer D in the plurality of software developers, an evaluation of both a productivity and a financial efficiency of the software developer D.

2. The method of claim 1, wherein (B) comprises, for each change C in a plurality of changes made by the software developer D to the source code:
identifying a number of insertions made by the software developer D into the source code as part of the change C;
identifying a number of deletions made by the software developer D in the source code as part of the change C;
identifying a rate of change of a file in the source code; and
identifying a complexity measure of a file in the source code;
and wherein computing the summary metric for the software developer D comprises:
computing a sum of the number of insertions and the number of deletions;
dividing the sum by the rate of change to produce a quotient;
computing a complexity of the source code; and
multiplying the quotient by the Halstead complexity of the source code to generate an impact score associated with the change C and the software developer D;
thereby generating a plurality of impact scores associated with the plurality of changes made by the software developer D to the source code.

3. The method of claim 2, further comprising:
computing a sum of the plurality of impact scores to produce the summary metric for the software developer D.

4. The method of claim 2, wherein computing the complexity of the source code comprises computing a Halstead complexity of the source code.

5. (canceled)

6. The method of claim 1, further comprising, for each of the plurality of software developers:
multiplying the software developer's preliminary financial efficiency score by a first predetermined factor to produce a first intermediate financial efficiency score for the software developer;
applying a sigmoid function to the first intermediate financial efficiency score for the software developer to produce a second intermediate financial efficiency score for the software developer; and
multiplying the second intermediate financial efficiency score for the software developer by a second predetermined factor to produce a final financial efficiency score for the software developer.

7. The method of claim 1, wherein (A) comprises:
establishing a link to the work product data source;
retrieving the work product data from the work product data source via the link, without directly accessing a work product data source's data environment.

8. The method of claim 7, wherein establishing the link to the work product data source comprises using OAuth technology to establish the link to the work product data source.

9. (canceled)

10. The method of claim 1, wherein (B)(2) comprises performing sentiment analysis on the ingested data.

11. The method of claim 1, wherein (B)(2) comprises performing theme extraction on the ingested data.

12. The method of claim 1, wherein (B)(2) comprises performing security vulnerability identification on the ingested data.

13. The method of claim 1, wherein (C) comprises performing financial transaction outlier detection on the ingested data.

14. A system comprising at least one non-transitory computer-readable medium having computer program instructions stored thereon, the computer program instructions being executable by at least one computer processor to perform a method, the method comprising:
(A) generating ingested data, comprising:
(A)(1) installing an agent software application on a local computer system of a work product data source and using the agent software application to retrieve work product data from the work product data source;
(A)(2) processing the work product data from the work product data source, the work product data comprising source code and associated metadata, wherein the associated metadata links each of a plurality of contributions within the source code to at least one of a plurality of software developers who are responsible for that contribution;
(A)(3) processing financial data from a financial data source, the financial data containing compensation data related to the plurality of software developers;
(B) analyzing the ingested data to generate worker performance metrics based on the contributions of the plurality of software developers to the source code, comprising generating, for each software developer D in the plurality of software developers, a corresponding summary metric, comprising:
(B)(1) identifying a quantity of the software developer D's contribution to the source code;
(B)(2) identifying a quality of the software developer D's contribution to the source code, comprising:
(B)(2)(i) generating high-dimensional vector embeddings of textual data associated with the software developer D's contribution to the source code; and
(B)(2)(ii) applying clustering techniques to the high-dimensional vector embeddings to identify quality characteristics of the software developer D's contribution to the source code;
(B)(3) identifying a permanence of the software developer D's contribution to the source code; and
(B)(4) computing the summary metric for the software developer D based on the identified quantity, quality, and permanence of the software developer D's contribution to the source code, wherein computing the summary metric comprises computing a Halstead complexity of the source code;
(C) analyzing the ingested data to generate financial efficiency metrics, comprising comparing the worker performance metrics with the compensation data to generate an assessment of the cost-effectiveness of each of the plurality of software developers' contributions to the source code, wherein generating the financial efficiency metrics comprises calculating a financial efficiency score for each of the plurality of software developers, comprising:
computing a performance percentile for each of the plurality of software developers, comprising calculating the performance percentile based on a comparison of the software developer's contributions to the source code against contributions from a peer group;
computing a compensation percentile for each of the plurality of software developers, comprising calculating the compensation percentile based on a software developer's total compensation relative to a total compensation of the peer group; and
for each of the plurality of software developers, subtracting the software developer's compensation percentile from the software developer's performance percentile to produce a preliminary financial efficiency score for the software developer;
(D) synthesizing the worker performance metrics and the financial efficiency metrics into an analytical output; and
(E) generating a synthesized output based on the analytical output, wherein the synthesized output represents, for each software developer D in the plurality of software developers, an evaluation of both a productivity and a financial efficiency of the software developer D.

15. The system of claim 14, wherein (B) comprises, for each change C in a plurality of changes made by the software developer D to the source code:
identifying a number of insertions made by the software developer D into the source code as part of the change C;
identifying a number of deletions made by the software developer D in the source code as part of the change C;
identifying a rate of change of a file in the source code; and
identifying a complexity measure of a file in the source code;
and wherein computing the summary metric for the software developer D comprises:
computing a sum of the number of insertions and the number of deletions;
dividing the sum by the rate of change to produce a quotient;
computing a complexity of the source code; and
multiplying the quotient by the Halstead complexity of the source code to generate an impact score associated with the change C and the software developer D;
thereby generating a plurality of impact scores associated with the plurality of changes made by the software developer D to the source code.

16. (canceled)

17. The system of claim 15, wherein the method further comprises, for each of the plurality of software developers:
multiplying the software developer's preliminary financial efficiency score by a first predetermined factor to produce a first intermediate financial efficiency score for the software developer;
applying a sigmoid function to the first intermediate financial efficiency score for the software developer to produce a second intermediate financial efficiency score for the software developer; and
multiplying the second intermediate financial efficiency score for the software developer by a second predetermined factor to produce a final financial efficiency score for the software developer.

18. The system of claim 14, wherein (A) comprises:
establishing a link to the work product data source;
retrieving the work product data from the work product data source via the link, without directly accessing a work product data source's data environment.

19. (canceled)

20. The system of claim 14, wherein (B)(2) comprises performing sentiment analysis on the ingested data.

21. The system of claim 14, wherein (B)(2) comprises performing theme extraction on the ingested data.
